(19) United States
(12) Patent Application Publication
(10) Pub. No.: US 2009/0021474 A1
(43) Pub. Date: Jan. 22, 2009

(54) SYSTEM AND METHOD FOR DISPLAYING STATUS INFORMATION OF A MULTIMEDIA BROADCAST RECEIVER ON AN AMBIENT DEVICE

(75) Inventors: FRANK R. BENTLEY, PALATINE, IL (US); GUNNAR F. HARBOE, EVANSTON, IL (US); NOEL S. MASSEY, CARPENTERSVILLE, IL (US); CRYSTA J. METCALF, CARY, IL (US); GUY G. ROMANO, ELMHURST, IL (US); JOSEPH C. TULLIO, CHICAGO, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/778,717

(22) Filed: Jul. 17, 2007

(51) Int. Cl. G09G 5/00

(52) U.S. Cl. 345/156

(57) ABSTRACT

There is provided a system for providing status information associated with viewing behavior of media broadcasting. The system comprises a client device that includes a receiver to receive presence data from a remote device and a processor to generate an ambient command based on the presence data. The presence data is associated with broadcast programs of the remote device, and the ambient command represents viewing information of the broadcast program at the remote device. The system also comprises an ambient component that provides an ambient representation of the viewing information based on the ambient command. The ambient component may be an integral part of the client device or a separate component that communicates with the client device via wired or wireless connection.

### FIELD OF THE INVENTION

The present invention relates generally to the field of media broadcast receivers, such as televisions. The present invention is more particularly directed to an ambient display for displaying status information associated with a media broadcast receiver.

### BACKGROUND OF THE INVENTION

Watching television alone is often an isolating activity. As friends and family are often in their own homes watching television independently, researchers are creating systems that help people make this activity more social. To this end, systems are being created that allow television viewers to see presence information of others, such as information about the programming that their family and friends are watching and information about who is currently watching television. These systems have various shortcomings. For one, the presence information is displayed on the television screen and takes up valuable screen real estate. As a result, the information may block part of the content and/or reducing the size of the content to a non-optimal size. For another, there is no way to get a sense of who is watching television without actually turning on the television. Thus, people will miss out on opportunities to have a shared experience around watching television.

An ambient device is a special-purpose device that may be placed in a user's environment to display information from a particular source or sources. Ambient devices are often consumer electronics that are characterized by their ability to be perceived at-a-glance, i.e., “glanceable”. Ambient devices display information based on pre-attentive processing, which is the ability of a person to perceive the displayed information with minimal cognitive effort, i.e., in the absence of attention. Preattentive processing is possible by displaying simple, non-textual properties representing change, such as color, size, motion, and luminance.

One type of ambient display conveys a variety of information through color changing lamps and physical gauges. Specifically, a server receives data and sends an abstracted form of the incoming data over a network to a remote ambient device. All processing occurs at the server, remote from the ambient device, and the abstracted data is optimized for presentation at the ambient display. Another type of ambient device is a color-changing lamp that changes illumination based on information encoded in a television broadcast signal. Unfortunately, these types of devices do not provide presence information about media broadcast viewing and do not allow for easy integration with, and customization for existing broadcast systems.

Accordingly, there is a need for an improved system and method for providing presence information of media broadcast viewing to remote viewers in order to enhance social networking.

### BRIEF DESCRIPTION OF THE DRAWINGS

FIG. 1 is state representation of an example system in accordance with the present invention.

FIG. 2 is a system diagram of an example embodiment in accordance with the present invention.

FIG. 3 is a block diagram illustrating example components of a client device in according with the present invention.

### DETAILED DESCRIPTION OF THE EMBODIMENTS

There is described a system and method that make aspects of status information associated with viewing behavior on an ambient component internal or external to a media broadcast receiving device, such as a television. This information is visible at a glance, so anyone walking near the device and its proximity can see this information even when the device is off. Also, even when the device is on, this information may add to one's awareness of other's current TV-watching states, i.e., the ambient component is always-on. This ambient component can also be used to get the user's attention, for example to remind them that something that they want to watch is on, or that a friend is inviting them to watch media broadcast receiving devices together, i.e., concurrently.

The ambient component may indicate a variety of information relating to one's own state or the state of others logged into the system. For examples, the device may indicate, but is not limited to:

how many friends and/or family are currently watching TV;

whether a particular person is currently watching TV;

how many friends and/or family are watching the TV show you are watching;

the nationwide/worldwide popularity of the show you are watching;

whether you are currently sharing your TV presence information;

whether you have scheduled yourself to watch a show at this time;

whether a friend has invited you to watch television with them at this time;

whether you have a new message from another user of the system; and

whether a show you might want to watch, based on previous viewing data/preferences, is on at this time.

The ambient component may be physically connected to, or integrated within, a client device, such as a set top box. The client device may be any type of electronic device that is capable of processing presence data received from a remote device and commanding an ambient component to provide an ambient representation of the viewing information. The ambient component may, in the alternative, be wirelessly connected locally (such as, a Bluetooth or Wi-Fi link) or remotely (such as, via cellular or paging data networks). For one embodiment, a home may have a variety of these devices that show the same or different information about television viewing states. Additionally, the device may be personalized to send information tailored to whoever is within a certain proximity to the device. Examples of client devices include, but are not limited to, networked appliances such as set top boxes and televisions, wireless communication devices such as cellular or ad hoc communication devices, computing devices such as portable computers and personal digital assistants, networked entertainment devices such as MP3 players and portable video viewers, and the like.

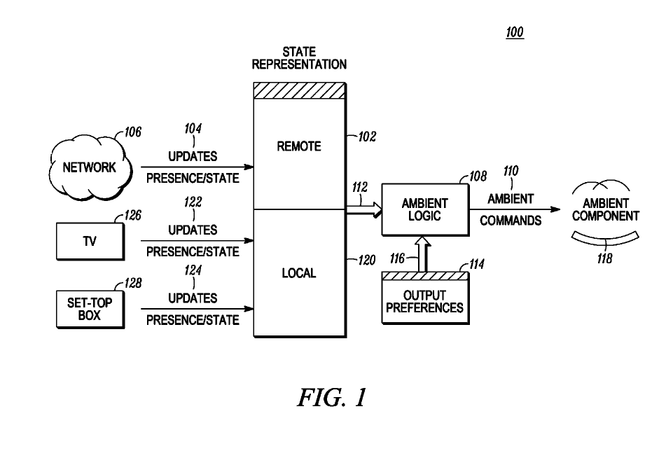

Referring to FIG. 1, a state representation of an example system 100 in accordance with the present invention is shown. The example system 100 provides status information associated with viewing behavior of media broadcasting. The types of viewing behavior include the viewing behavior of a local user, the viewing behavior of a contact of the local user, the viewing behavior of a pre-defined or ad-hoc group of users, reminders to watch a show, and invitations or message from other users.

The example system 100 includes a receiver 102, or a receiver portion of a transceiver, which is capable of receiving presence data or updates 104 from a network 106. The presence data is associated with broadcast programs of a remote device that communicates the receiver 102 via the network 106. The remote device identifies and provides the presence data of a remote user, known to the local user, who is viewing a remote display, such as a set top box coupled to a television viewed by a user identified the local user's contact list (stored in the set top box or television) but located at a different location. For example, a remote display may be situated in a room or building different from the room or building of the local display, such as a friend or family member viewing broadcast programming in a different room or dwelling. Examples of remote displays include, but are not limited to, networked appliances such as set top boxes and televisions, wireless communication devices such as cellular or ad hoc communication devices, computing devices such as portable computers and personal digital assistants, networked entertainment devices such as MP3 players and portable video viewers, network devices such as servers, and the like.

Broadcast programs include analog or digital media content that may be stored at a variety of location or received from a variety of sources. For one embodiment, a broadcast program may be received from a multimedia broadcast providing multiple channels, in which each channel may be tuned at a particular frequency range. For another embodiment, a broadcast program may be stored at a digital video recorder, such as its hard drive or other storage device. For yet another embodiment, a broadcast program may be stored on a digital versatile disc (DVD) that is played by an integrated or detached DVD player. The source(s) of content of one or more of these embodiments include, but are not limited to, traditional broadcast, video on demand, IPTV, Internet download, podcasting, and the like.

The system 100 further includes a processor 108, such as an ambient logic, that generates an ambient command 110 based on the viewing behavior of the remote user, i.e., the presence data 104. If the processor 108 is separate from the receiver 102, then the processor 108 may receive the presence data from the receiver via link 112. The ambient command 110 represents aggregate viewing information of at least one broadcast program at one or more remote devices, and utilizes pre-attentive processing to provide the viewing information. If the viewing information of only one remote device or only one broadcast program is processed, then the ambient command will represent that particular viewing information. If the viewing information of more than one remote device or more than one broadcast program are processed, then the ambient command will represent the viewing information of these devices and/or programs. Of course, the ambient command may also aggregate other types of information that are available, as describe herein. Accordingly, the ambient command is an abstracted form of the presence data that represents simple, non-textual properties representing change. Examples of simple, non-textual properties include, but are not limited to, color, light intensity, sound, motion tactile feedback, scent, and the like.

The processor 108 may generate the ambient command 110 based on the presence data 104 by converting it to an ambient command 110 or by processing the presence data in combination with other data, such as the presence data of the local user, the state data of the local user, the state data of the remote user, and/or the current state of the client device. The processor 108 may further generate the ambient command 110 based on the presence data 104 by processing the presence data, with or without other data, in combination with output preferences 114. Output preferences 114 may be stored in a memory and provided to the processor 108 via link 116. The processor 108 is capable of customizing the ambient command 110 based on the capabilities specific to the ambient component 118, as identified by the output preferences 114. The ambient component 118 provides an ambient representation of the viewing information based on the ambient command 110 of the processor 108, so that the ambient command may be perceived at-a-glance by the local user. The ambient component 118 would change state in response to receiving the ambient commend 110.

For another embodiment, the processor 108 may generate the ambient command 110 based on raw presence data or state data 104 received from a remote user via the network 106, raw presence data or state data 122, 124 received from a local component, the current state of the client device stored in a memory, or a combination thereof For example, in order to determine how many friends & family are watching the television show you are watching, the remote presence data 104 from a remote set top box or television and the local presence data 122, 124 would be considered. As another example, in order to determine the nationwide/worldwide popularity of the show you are watching, the remote state data 104 from a remote server and the local presence data 122, 124 would be considered. As yet another example, to notify a local user about an incoming message while indicating the popularity of the show you are watching, the processor 108 would combine the remote state data 104 identify the incoming message and the current state of the client device, which indicates the popularity, to generate the ambient command 110.

It should be noted that the remote and local state data may be provided by one or more sensors for detecting light, sound, odor, motion, connectivity and power. For example, a power meter may be coupled to the power input of a set top box or television in order to determine whether the device is powered on or off. The power meter may provide the state data regarding the current power state of the device to the local receiver 120 of the client device. For one embodiment, a power meter may be connected to the set top box or television of the remote device in order to determine the presence data of the remote device, which would be forwarded to the client device via network 106.

The sensors may be integrated with one or more devices, such as the client device, a television 126, or a set top box 128, or they may be separate components which communicate with the devices. For another embodiment, a client device, such as the television 126 or set top box 128, may identify the viewing presence of a user viewing a local display. For example, if the client device is tuned to a particular channel, then the system may assume that any user or users associated with the client device is viewing the particular channel. The client device may also be tuned to more than one channel if the television is capable of displaying multiple channels simultaneously, such as split-screen or picture-in-picture functionality.

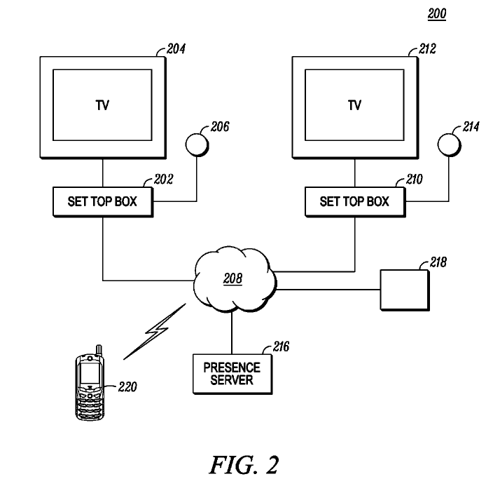

Referring to FIG. 2, there is shown an example embodiment 200 of a system for providing status information associated with viewing behavior of television broadcasting in accordance with the present invention. The embodiment 200 includes a client device, such as first set top box 202 shown in FIG. 2, coupled to a local display 204 that is capable of displaying media broadcast programs, such as a television capable of displaying television shows. The first set top box 202 is configured to receive multiple broadcast programs from a remote source, such as a national or regional broadcasting company, and provide a local subset of the broadcast programs to the local display 204. For example, the first set top box 202 may include a tuning circuit that selects the local subset of the broadcast programs based on one or more frequencies associated with the local subset. The local subset may only include one channel tuned at a particular frequency range or, as explained above, may include more than one channel with each channel tuned to a particular frequency range. The embodiment 200 may further include an ambient component 206 configured to receive viewing information from the first set top box 202 and provide an ambient command representative of an abstract form of the viewing information. For example, the ambient component 206 may include multiple light sources, and the ambient command may determine which light source or light sources may be illuminated. Also, the ambient component 206 may include a single light source or multiple light sources, in which each light source may change color and/or intensity of illumination based on the ambient command. Further, the ambient component 206 may provide audio and/or motion output instead of, or in addition, to visual output. For example, the ambient component 206 may have shape-changing characteristics, such as an animatronic puppet, and sounds. The ambient component 206 may provide light, color, sound, movement/shape changing, changing graphical icons on a display, and the like. In addition, for another embodiment, where multiple ambient components exist, the client device may send viewing information based on predetermined criteria, such as sending commands to the ambient component closest to the client device. The client device and ambient component may provide information other than the viewing information, such as the state of the client device, information about the content (e.g., genre, title) selected by the local user or a remote user, and additional information that is not directly related to the media broadcast.

It should be noted that the ambient component 206 may be separate from the first set top box 202 and/or the local display 204, as shown in FIG. 2, or the device may be an integral part of the first set top box and/or the local display so that the ambient command may be observed from an external area of the set top box. If separate, then the ambient component 206 may communicate with the first set top box 202 via a wired or wireless communication link. For example, the ambient component 206 may be a home Wi-Fi solution, a wireless serial connection, a wireless USB connection, or through broader networks such as cellular, WiMax, etc. Also, the client device, such as the first set top box 202, may communicate directly with the ambient component 206, or indirectly through one or more intermediate devices, such as a server which re-broadcasts messages from the client device to one or more ambient components. As alternatives to the client device and the local display, the ambient component 206 may also be integrated with other devices, such as microphones, remote controls or wireless communication devices.

In addition to the local display 204 and the ambient component 206 (if separate), the first set top box 202 may also communicate with other components through a network 208, such as a communication network or packet data network. The first set top box 202 may communicate, via the network 208, to a second set top box 210 which may or may not be coupled (wired or wirelessly) to a second display 212 or a second ambient component 214. The second set top box 210 is located remote from the first set top box, such as being located in a different building or a different room of the same building. The second set top box 210 may provides a second subset of broadcast programs associated with the second display 212. The first set top box 202 may further communicate with one or more servers 216 and other components or networks 218 via the network 208. The server(s) 216 may be utilized to store raw presence data and/or manage the transfer of raw presence data to the first set top box 202. It is important to note, however, that determination of the viewing information based on the raw presence data is performed by the first set top box 202. In the alternative, the server(s) 216 may assist the first set top box 202 to generate the viewing information, but at least part of the operation of generating the viewing information must be performed by the client device. For example, a server 216 may pre-process the presence data is pre-processed for the client device.

The first subset of broadcast programs and the raw presence data may be received by the first set top box 202, or its associated components, via the same network link or a different network link. For example, the broadcast programs may be received by the first set top box 202 via a first network link (not shown), and the second subset of the broadcast programs may be received by the first set top box via a second network link 208 different from the first network link.

The client device, such as a set top box, and/or the ambient component may store user preference information associated with at least one user of the first set top box 202 and generates the viewing information based on the preference information as well as the first and/or second subset of the broadcast programs. The preference information may include, but is not limited to, identification of associate users (such as friends and/or family), whether a user's viewing information may be shared with others, scheduling information about particular programs selected by a user, and/or previous viewing data/preferences of a user.

The set top boxes 202, 210 may be able to receive raw presence data from other devices via the network 208 about broadcast viewing. This data may be established by detecting the currently tuned channel and its appropriate metadata, and sharing the data via P2P means or through the presence server 216. When each set top box 202, 210 receives this data, it can determine how to change the ambient command of the ambient component 206, 214 based on these inputs and, optionally, additional inputs from its own state. For example, it could be set to change colors based on the number of people in an instant messaging contact list currently watching television or other conditions. Each set top box 202, 210 may then send the appropriate commands to the ambient component 206, 214, and the user associated with each set top box may become aware of this condition the next time he or she looks at the ambient component.

It should be noted that alternative components 220 may substitute for the set top boxes 202, 210 and/or displays 204, 206, 204, 212 of the embodiment represented by FIG. 2. Examples of alternative components 220 include, but are not limited to, wireless communication devices such as cellular or ad hoc communication devices, computing devices such as portable computers and personal digital assistants, networked entertainment devices such as MP3 players and portable video viewers, and the like. The features of the set top boxes 202, 210 and/or displays 204, 206, 204, 212 may be integrated or provided by separate, communicating components so long as they function in accordance with the present invention.

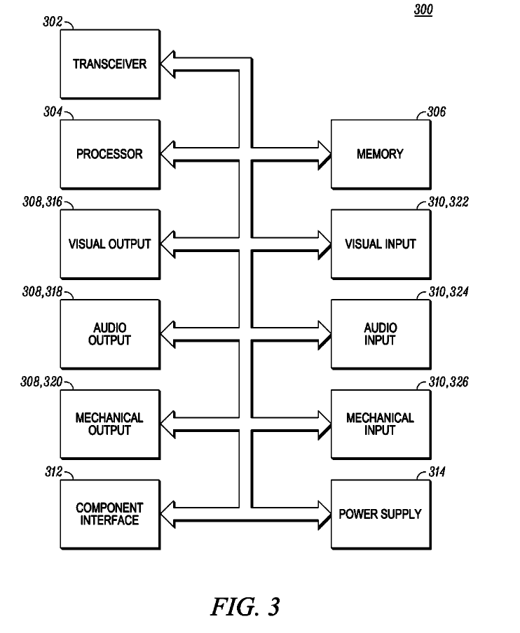

Referring to FIG. 3, there is provided a block diagram illustrating exemplary internal components 300 of the client device and/or remote device in accordance with the present invention. The exemplary embodiment includes one or more wired or wireless transceivers 302, a processor 304, a memory portion 306, one or more output devices 308, and one or more input devices 3 10. Each embodiment may include a user interface that comprises one or more output devices 308 and one or more input device 3 10. Each transceiver 302 may be directly wired to another component or utilize wireless technology for communication, such as, but are not limited to, cellular-based communications such as analog communications (using AMPS), digital communications (using CDMA, TDMA, GSM, iDEN, GPRS, or EDGE), and next generation communications (using UMTS, WCDMA, LTE or IEEE 802.16) and their variants; a peer-to-peer or ad hoc communications such as HomeRF, Bluetooth and IEEE 802.11 (a, b, g or n); and other forms of wireless communication such as infrared technology. Each transceiver 302 may be a receiver, a transmitter or both. For example, for one embodiment of the client device, a transmitter may be a receiver, or include a receiver portion, that is configured to receive presence data from a remote device.

The processor 304 may generate the ambient command 110 based on the presence data 104 by converting it to an ambient command 110 or by processing the presence data in combination with other data, such as the information stored in the memory portion 306. The processor 304 may further generate the ambient command 110 based on the presence data 104 by processing the presence data, with or without other data, in combination with output preferences 114, which is also stored in the memory portion 306. The processor 108 may generate the ambient command 110 based on raw presence data or state data 104 received from a remote user via the network 106, raw presence data or state data 122, 124 received from a local component, the current state of the client device stored in a memory, or a combination thereof.

The internal components 300 may further include a component interface 312 to provide a direct connection to auxiliary components or accessories for additional or enhanced functionality. Auxiliary components or accessories that may communicate with the transceiver 302 and/or component interface 312 include one or more sensors for detecting light, sound, odor, motion, connectivity and power to produce the remote and local state data. The internal components 300 preferably include a power source 314, such as a power supply or portable battery, for providing power to the other internal components.

The input and output devices 308, 310 of the internal components 300 may include a variety of video, audio and/or mechanical outputs. For example, the output device(s) 308 may include a video output device 316 such as a cathode ray tube, liquid crystal display, plasma display, incandescent light, fluorescent light, front or rear projection display, and light emitting diode indicator. Other examples of output devices 308 include an audio output device 318 such as a speaker, alarm and/or buzzer, and/or a mechanical output device 320 such as a vibrating, motion-based, or animatronic mechanism. Likewise, by example, the input devices 310 may include a video input device 322 such as an optical sensor (for example, a camera), an audio input device 324 such as a microphone, and a mechanical input device 326 such as button or key selection sensors, touch pad sensor, touch screen sensor, capacitive sensor, motion sensor, and switch. Other output devices 308 may include scent generating or releasing devices, and other input devices 310 may include scent detection sensors.

The memory portion 306 of the internal components 300 may be used by the processor 304 to store and retrieve data. The data that may be stored by the memory portion 306 include, but is not limited to, operating systems, applications, and data. Each operating system includes executable code that controls basic functions of the client or remote device, such as interaction among the components of the internal components 300, communication with external devices via each transceiver 302 and/or the component interface 312, and storage and retrieval of applications and data to and from the memory portion 306. Each application includes executable code utilizes an operating system to provide more specific functionality for the client or remote device. Data is non-executable code or information that may be referenced and/or manipulated by an operating system or application for performing functions of the client or remote device. Examples of data stored by the memory portion 306 includes, but are not limited to, raw presence data or state data 104 received from a remote user via the network 106, raw presence data or state data 122, 124 received from a local component, the current state of the client device, and/or output preferences 114. The processor 304 is capable of customizing the ambient command 110 based on the capabilities specific to the ambient component 118, as identified by the output preferences 114.

The memory portion 306 of the client device may be further configured to store a contact list, which includes an entry of the contact list is associated with the remote device. The contact list may be created by a user interface of the input device 310, downloaded from another device or a server via the network 106, 208, or downloaded from another device of the user, or a combination of these methods. For one example, the contact list may be downloaded from a computing device or communication device having a wired or wireless link to the client or remote device. For another example, a global or superset list may be provided by a server via the network 106, 208 and a user interface of the input device 310 may be used to filter or reduce the number of contacts in the list or generate a smaller list.

It is to be understood that FIG. 3 is for illustrative purposes only and is for illustrating components of a client device in accordance with the present invention, and is not intended to be a complete schematic diagram of the various components required for a client or remote device. Therefore, a client or remote device may include various other components not shown in FIG. 3, or may include a combination of two or more components or a division of a particular component into two or more separate components, and still be within the scope of the present invention.

The above embodiments offer experiences in the home that encourage socialization around television viewing. Users may use this television presence information when they are not watching television to bring them into the television-viewing experience, and they may become curious about who is watching television and what they are watching. Also, the reminding and inviting functionality will likely bring people into the television experience when they previously would not have turned on the television and, thus, missed a program that they had wanted to watch or someone else thought that they should watch. Finally, while watching television, the above embodiments may enable users to stay better informed about what others are watching and when friends join or leave the social television experience without being distracted from their own television viewing.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A client device for providing status information associated with viewing behavior of media broadcasting, the device comprising:
a receiver configured to receive presence data from a remote device, the presence data being associated with broadcast programs of the remote device;
a processor configured to generate an ambient command based on the presence data, the ambient command representing aggregate viewing information of at least one broadcast program at one or more remote devices; and
an ambient component configured to provide an ambient representation of the aggregate viewing information based on the ambient command of the processor.

2. The client device of claim 1, wherein the ambient signal utilizes pre-attentive processing to provide the aggregate viewing information.

3. The client device of claim 1, wherein the ambient command is an abstracted form of the presence data.

4. The client device of claim 1, further comprising a memory configured to store output preferences associated with the client device, wherein the processor generates the ambient command based on the output preferences in conjunction the presence data.

5. The client device of claim 1, further comprising a memory configured to store a contact list, which includes an entry associated with the remote device.

6. The client device of claim 1, wherein the presence data is pre-processed by a remote server.

7. The client device of claim 1, wherein:
the memory store a current state of the client device; and
the processor generates the ambient command based on the presence data in conjunction with the current state of the client device.

8. The client device of claim 1, wherein:
the receiver is configured to receive a state update from a local component; and
the processor is configured to generate the ambient command based on the presence data in conjunction with the state update from the local component.

9. The client device of claim 1, wherein:
the presence data from the remote device is a first presence data;
the receiver is configured to receive a second presence data from a local component; and
the processor is configured to generate the ambient command based on the first and second presence data.

10. A system for providing status information associated with viewing behavior of media broadcasting, the system comprising:
a client device configured to receive presence data from a remote device and generate an ambient command based on the presence data, wherein the presence data is associated with broadcast programs of the remote device and the ambient command represents aggregate viewing information of at least one broadcast program at one or more remote devices; and
an ambient component, communicating with the client device, configured to provide an ambient representation of the aggregate viewing information based on the ambient command of the client device.

11. The system of claim 10, further comprising a media broadcast receiver capable of providing at least one broadcast programs.

12. The system of claim 10, wherein the ambient signal utilizes pre-attentive processing to provide the aggregate viewing information.

13. The system of claim 10, wherein the ambient command is an abstracted form of the presence data.

14. The system of claim 10, wherein the client device is configured to store output preferences and generate the ambient command based on the output preferences in conjunction the presence data.

15. The client device of claim 10, wherein the client device is configured to store a contact list, which includes an entry associated with the remote device.

16. The client device of claim 10, wherein the presence data is pre-processed by a remote server.

17. The client device of claim 10, wherein the client device stores a current state of the client device and generates the ambient command based on the presence data in conjunction with the current state of the client device.

18. The client device of claim 10, wherein the client device is configured to receive a state update from a local component and generate the ambient command based on the presence data in conjunction with the state update from the local component.

19. The client device of claim 10, wherein:
the presence data from the remote device is a first presence data;
the client device is configured to receive a second presence data from a local component and generate the ambient command based on the first and second presence data.

20. A system for providing status information associated with viewing behavior of media broadcasting, the system comprising:
a network;
a first client device communicating with the network, the first client device being configured to provide presence data associated with viewing information of a broadcast program at the client device;
a second client device communication with the network, the second client device being configured to receive the presence data from the first client device via the network and cause an ambient component to provide an ambient representation of aggregate viewing information, wherein the aggregate viewing information includes the viewing information of the broadcast program at the client device.
